(19) United States
(12) Patent Application Publication
(10) Pub. No.: US 2013/0189659 A1
(43) Pub. Date: Jul. 25, 2013

(54) Appraisal Process Framework for Scrum Projects

(71) Applicants: Milind Halageri, Ranebennur (IN); Shivaram Venkat, Bangalore (IN); Ganapati Kamath, Ralajinagar Bangalore (IN); Ganesh Subramanian, Bangalore (IN); Venkata Ratna Maddi, Bangalore (IN)

(72) Inventors: Milind Halageri, Ranebennur (IN); Shivaram Venkat, Bangalore (IN); Ganapati Kamath, Ralajinagar Bangalore (IN); Ganesh Subramanian, Bangalore (IN); Venkata Ratna Maddi, Bangalore (IN)

(21) Appl. No.: 13/561,520

(22) Filed: Jul. 30, 2012

Related U.S. Application Data
(60) Provisional application No. 61/557,575, filed on Nov. 9, 2011.

(30) Foreign Application Priority Data
Feb. 7, 2012 (IN) 340/DEL/2012

(51) Int. Cl. G09B 19/00

(52) U.S. Cl. CPC G09B 19/00
USPC 434/236

(57) ABSTRACT

A method for computing appraisal information concerning an individual which comprises receiving, by a server, questionnaire responses evaluating the individual from a plurality of client devices, the questionnaire responses including (i) self evaluation responses, by the individual, to a plurality of questions and (ii) peer evaluation responses, by peers of the individual, to the plurality of questions; computing appraisal information from the questionnaire responses, by: (i) for each question, computing an aggregate peer evaluation from peer evaluation responses corresponding to that question; and (ii) for each question, computing a metric indicative of a discrepancy between a self perception of the individual's performance as indicated in the self evaluation response corresponding to that question and a peer perception of the individual's performance as indicated in the aggregate peer evaluation corresponding to that question, the appraisal information including the computed metric.

### FIELD OF THE INVENTION

This application relates to methods for measuring individual and team performance in teams, such as scrum teams, and especially in self-managed teams.

### BACKGROUND

In the past, a waterfall model has been used in software development processes. The waterfall model is so named because its progress is seen as flowing steadily “downwards,” like a waterfall. In a waterfall methodology, a project may progress through the steps of conception, initiation, analysis, design, construction, and testing, production/implementation and maintenance. Certain deficiencies are associated with the waterfall model, such as difficulties in adapting to changing customer needs. The many sequential steps also tend to result in a slow software development cycle.

More recently, other software development processes have been developed, such as Agile, so named because it is viewed as being allegedly more agile than, for example, a methodology based on a waterfall model. The software development phases in Agile are typically less defined than in a waterfall model. Development cycles are also shorter, allowing for a faster response to changing customer needs.

A particular variation of Agile is known as Scrum. In Scrum, employees are typically organized into self-managed teams (i.e., scrum teams), where each team has three primary roles: a product owner, scrum master, and development team members. The product owner is a person interacting with the customer, researching customer needs and making sure that those needs are fulfilled by the scrum team. The scrum master makes sure that the scrum process, further described below, is followed. Development team members, typically composed of five to nine people, are responsible for delivering a product, such as a software module, software update, etc. A single person may perform both roles of scrum master and development team member, but typically a person does not perform both roles of product owner and scrum master.

In the scrum process, a project is divided into project cycles, the smallest cycle called a “sprint”. Lasting anywhere from a week to a month, a sprint begins with a planning meeting, and concludes with a sprint review meeting and a sprint retrospective. In the planning meeting, tasks are identified and aggregated into a “backlog” (i.e., list). After the planning meeting, development team members work to complete respective tasks. In the sprint review meeting, completed and incomplete work is reviewed, and completed work (e.g., a product) is presented to the customer. In the sprint retrospective, each member of the scrum team reflects on the sprint, addressing what went well during the sprint, what could be improved during the next sprint, etc.

During a sprint review meeting and/or a sprint retrospective, self evaluation and peer evaluation may be conducted. While much literature concerning such self evaluation and peer evaluation exists, it does not appear such literature provides an appraisal framework, specifically adapted for self-managed teams, as described below.

### SUMMARY

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

In one embodiment, a computer-implemented method for computing appraisal information concerning an individual, comprises receiving, by a server, questionnaire responses evaluating the individual from a plurality of client devices, the questionnaire responses including (i) self evaluation responses, by the individual, to a plurality of questions and (ii) peer evaluation responses, by peers of the individual, to the plurality of questions; computing appraisal information from the questionnaire responses, by: (i) for each question, computing an aggregate peer evaluation from peer evaluation responses corresponding to that question; and (ii) for each question, computing a metric indicative of a discrepancy between a self perception of the individual's performance as indicated in the self evaluation response corresponding to that question and a peer perception of the individual's performance as indicated in the aggregate peer evaluation corresponding to that question, the appraisal information including the computed metric; and initiating the computed appraisal information to be transmitted from the server to an electronic display device.

In another embodiment, a computer-implemented method for computing appraisal information concerning a first and second individual, comprises receiving, by a server, questionnaire responses evaluating the first individual and questionnaire responses evaluating the second individual from a plurality of client devices, the questionnaire responses including (i) self evaluation responses, by the first and second individuals, to a plurality of questions and (ii) peer evaluation responses, by peers of the first and second individuals, to the plurality of questions; computing appraisal information from the questionnaire responses, by: (i) for each of the first and second individuals, computing an aggregate evaluation from questionnaire responses from a common evaluator; and (ii) facilitating a comparison between the aggregate evaluation of the first individual and the aggregate evaluation of the second individual, the appraisal information capturing the comparison; and initiating the computed appraisal information to be transmitted from the server to an electronic display device.

It is to be understood that both the foregoing general description and the following detailed description are exemplary and explanatory and are intended to provide further explanation of the invention as claimed.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 illustrates a flowchart for performing a performance evaluation, according to an exemplary embodiment.

FIG. 2 illustrates a system diagram, according to an exemplary embodiment.

FIG. 3 illustrates a flowchart for performing a performance evaluation, according to an exemplary embodiment.

FIG. 4 illustrates a review process, according to an exemplary embodiment.

FIG. 5 illustrates a tabular chart of appraisal information regarding a single evaluatee, according to an exemplary embodiment.

FIG. 6 illustrates a tabular chart of appraisal information regarding a single evaluatee, specifically including gap analysis, according to an exemplary embodiment.

FIG. 7 illustrates a bar chart of appraisal information generally regarding a single evaluatee, according to an exemplary embodiment.

FIG. 8 illustrates a tabular chart of appraisal information regarding multiple evaluatees, according to an exemplary embodiment.

FIG. 9 illustrates a line chart of appraisal information regarding multiple evaluatees, according to an exemplary embodiment.

FIG. 10 illustrates a bar chart of appraisal information regarding a team of individuals, according to an exemplary embodiment.

FIG. 11 illustrates a tabular chart of appraisal information regarding a team of individuals, according to an exemplary embodiment.

FIG. 12 illustrates a line chart of time-evolving appraisal information regarding a team of individuals, according to an exemplary embodiment.

FIG. 13 illustrates an arrangement of appraisal information generally regarding a single evaluatee, according to an exemplary embodiment.

FIG. 14 illustrates an arrangement of appraisal information regarding multiple evaluatees, according to an exemplary embodiment.

FIG. 15 illustrates a computing system, according to an exemplary embodiment.

### DETAILED DESCRIPTION

Various embodiments and aspects of the invention will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present invention.

Because a single person typically does not have knowledge about the performance of each member of a team, it can be difficult to manage the team. Instead, team members can provide peer-based feedback that focuses on the behavior of a member of the team, rather than on metrics to measure the productivity of that individual. A metric is typically used to measure the productivity of an individual (e.g., person A wrote 30 lines of code and person B wrote 34 lines of code). As a result, team members have incentive to focus on aspects that improve their metrics. A behavior, on the other hand, is a way to evaluate an individual's efforts put forth to achieve a goal (e.g., is a person passionate about a task, is a person able to quickly adapt to a new role or a new project). This new type of feedback may also allow an easier transition of new team members to an existing project, whereas those new members probably would not be able to catch up on the metrics. A questionnaire is given to each team member to rate themselves and the other team members. Rather than using a numerical scale (e.g., 1-4), in which each evaluator may interpret ratings differently, the questionnaire may use descriptive qualities like “always” or “sometimes.” These descriptive qualities can then be translated into a numerical score. Metrics may not be eliminated entirely and may still be used for measuring the productivity of an individual or team, but they are not solely used to measure performance.

The methods and systems described herein attempt to provide a performance evaluation framework that can be implemented in organizations for the management of the self-managed teams. While the new evaluation performance review framework attempts to not compromise on putting the team at the center instead of the individual, it still may allow and may take into account the classical individual performance based review mechanism. Additionally, the methods and systems described herein attempt to capture information on the “under the surface ice-berg” dynamics of the team that can help in constructive dialog at the time of a performance review.

With Agile becoming a methodology of choice for product development, it is becoming ever more critical to have a performance evaluation framework that does not compromise on the core principles of a team.

The methods and systems described herein may be based on one or more of the core behaviors expected in Agile teams, may make the following assumptions and/or may operate in the following ways:
The behavior of an individual may lead to one's performance in the workplace.
It may be beneficial to accommodate varying expectation (e.g., work load, compensation, etc.) among different engineer role codes (e.g., job positions).
It may be beneficial for an individual to retrospect and identify certain data points (e.g., skills, behaviors, etc.) for self improvement. Data points may reflect sprint values and goals.
An individual's own sprint team may be an ideal team to provide feedback for one's improvement, the feedback possibly including comprehensive justification.
It may be desirable for one to understand and analyze the team response pattern and cross correlate the data to identify what needs to be done to enhance team capabilities.
Each individual may have an opportunity to understand a perception gap that exists within the scrum ecosystem and set his/her own benchmark and work to achieve consistency, as well as to improve his/her skills.
Individual scores may be shared anonymously with a concerned person (e.g., evaluatee) allowing the concerned person to have open discussions with one or more team members (e.g., evaluators) to bridge any perception gap.

### Metrics and Methodology

A central objective of a performance review may be to improve an employee's capabilities. This in turn may improve the capabilities of the team and may enhance the productivity of the team. A performance review may also help to increase the revenue of an organization. From a business perspective, a performance review may attempt to satisfy employees, stakeholders and/or customers. A central driving force for an employee's satisfaction may be his/her passion for the work itself, followed by the work environment, compensation, and growth opportunities. In contrast, customer satisfaction may be driven by a decrease in costs and an increase in quality. Fortunately, both employee and customer satisfaction can be achieved by enhancing the capability of the team. An objective of an appraisal system may be to enhance the individual and team capability, while may only be loosely coupled with a compensation component.

In the past, organizations have been known to follow the waterfall or Rational Unified Process (RUP) methodology to execute projects. In this methodology, various data points may be captured and measured. Progress may be monitored using key performance indicators (KPIs) such as schedule overrun, effort overrun, effectiveness, in-process defect density, and productivity. These data points may be measured at the team level and data may be used for appraisal ratings.

However, the methodology used to execute Agile projects may not require that data points be captured for measuring or monitoring. The methodology may instead try to enhance scrum values and the scrum process, which may stand on transparency, inspection, and the sharing of knowledge between team members. Scrum values may be built on values such as ownership, commitment, self organization, transparency, and empowerment. These values may not be easily measured using conventional metrics. Instead, team members may be encouraged to seek the perception of others in the team and may ideally attempt to enhance their skills, which may more easily be achieved by measuring feedback from those in the development team, product owners, and people managers, against parameters which measure the scrum values.

A performance review may attempt to improve productivity (e.g., individual and team productivity) and enhance business (e.g., profits, revenue, etc.). However, in a conventional appraisal system, a manager may play a key role in identifying or labeling team members with terms such as Outstanding Performer, Average Performer, and Poor Performer. One embodiment of the new appraisal framework may be in stark contrast to a one-sided accountability framework and an appraisal review determined only from what is visible to the manager. One embodiment of the new framework may focus on multi-sided discussions to achieve goals and results set by an organization. An appraisal review in this framework may aim to enhance a team's capability and productivity.

An appraisal framework, in accordance with an exemplary embodiment, can be used by a scrum team to achieve the following benefits and/or tasks:
Understand the feedback pattern provided by a team, in light of scrum values.
Understand differences and similarities in individual perception of performance versus average team perception of performance, as related to scrum values.
Analyze time evolution of team performance with respect to scrum values.
Introspect and identify how to enhance values at the team level. An appraisal framework may also help those within a scrum team to identify best practices and propagate these practices for organization-wide use.

### Overview of Evaluation Framework

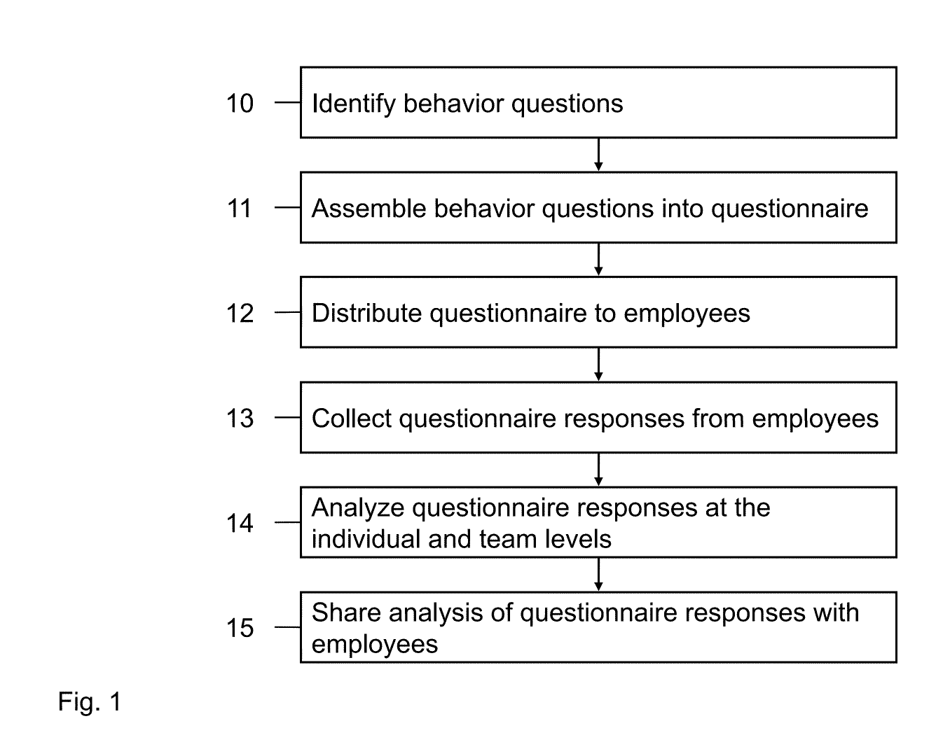

An appraisal framework, according to one exemplary embodiment, may focus on enhancing team and individual capabilities by revealing the perceptions (e.g., self perceptions, team perceptions) related to values (e.g., scrum values) within the a team (e.g., scrum team). One embodiment of the appraisal framework may proceed generally in accordance with the steps depicted in FIG. 1. In step 10, behavioral questions are identified. For example, a team (e.g., scrum team) and people manager (i.e., scrum master) may identify key behavioral questions in light of the scrum values and its processes. Specifically, behavioral questions may be chosen to reflect sprint values, such as ownership, commitment, self organization, transparency, and empowerment.

Sample questions for all engineers, second level engineers and third level engineers are now described. For all engineers, questions may include whether an engineer passionately takes on tasks or takes on tasks with reluctance, whether an engineer actively shares knowledge with others, whether an engineer can independently complete tasks, whether an engineer provides innovative solutions to problems, and whether an engineer is able to, in the midst of differing viewpoints, identify and focus on a common solution.

Questions for a second level engineer may include whether he/she can foresee dependencies between various task and whether he/she can foresee other problems, and resolve same before they arise, and whether he/she can effectively help new employees “get on board” (e.g., become familiar with company culture, best practices, etc.).

Questions for a third level engineer may include whether he/she is able to align the work of the team with overall company objectives, and whether he/she is able to coordinate between multiple teams (e.g., scrum teams) in resolving technical impediments.

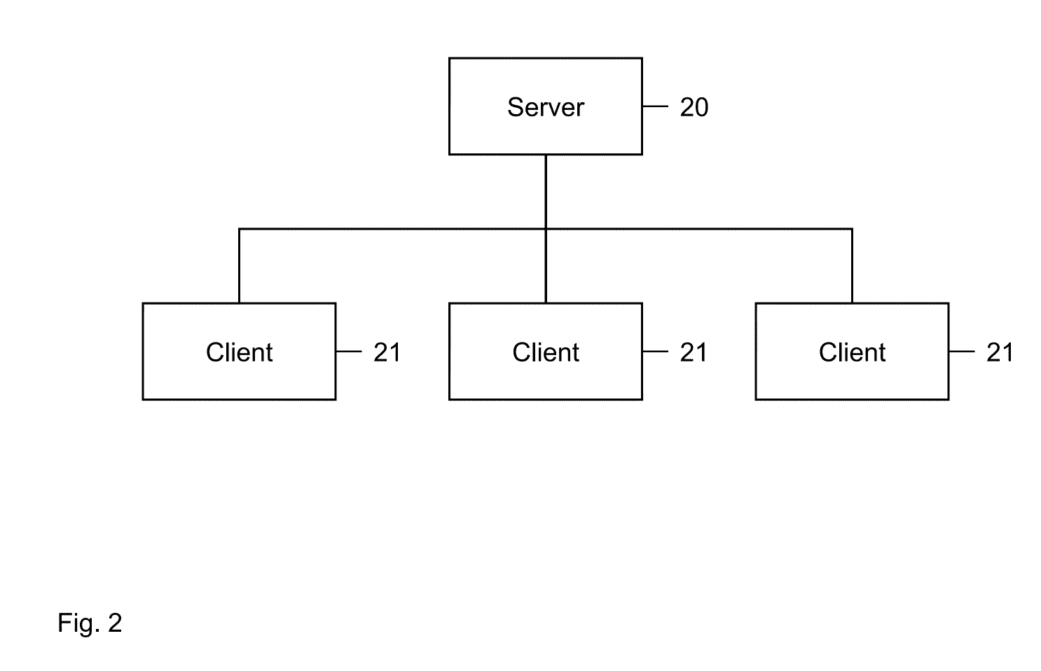

After behavioral questions have been identified, the behavioral questions may be assembled (step 11) into a questionnaire that is then distributed (step 12) to one or more employees, such as members of a scrum team. Questionnaires may be distributed in the client-server architecture depicted in FIG. 2, in which questionnaires (i.e., electronic versions thereof) are transmitted from server 20 to one or more client devices 21, such as workstations, portable digital assistants (PDAs), laptops, desktops, tablet computing devices, and the like. Client devices 21 may be communicatively connected to server 20 via a network, such as a local area network (LAN), wide area network (WAN), metropolitan area network (MAN), Internet, and the like. Such connection may be wired, wireless or both. It is noted that the labels “server,” “client” are used only to differentiate the roles of the devices depicted in FIG. 2. In practice, there may be no difference in the hardware components of a server and client device. Also, a single device may perform the functions of both a server and a client.

Questionnaire responses are collected from employees (step 13). In the client-server architecture depicted in FIG. 2, questionnaire responses (i.e., electronic versions thereof) may be transmitted from each client device 21 to server 20, where they are collected and organized into a data store. The data store may be part of server 20, or remotely located from the server. In providing questionnaire responses, each team member (e.g., scrum team member) may be requested to provide self ratings (e.g., a self evaluation) and/or ratings for each team member in the team (e.g., a peer evaluation). Along with providing a rating (e.g., numerical rating—1/2/3/4/5, descriptive rating—never/sometimes/always), each team member may be requested to provide specific examples in support of his/her rating. For example, in providing a rating indicating a team member is often passionate about his/her work, a comment may be provided stating, for example, John Smith is known to pass up vacations in order to help his team complete deliverables for a sprint due date.

At server 20, questionnaire responses may be analyzed at the team level and/or at the individual level (step 14). Data (e.g., response patterns, averaged/aggregated responses) may be cross correlated (e.g., individual responses correlated individual responses, individual responses correlated with team responses, team A's responses correlated with team B's responses) to identify measures to enhance individual skills and/or team capabilities. For example, an individual's performance for a certain question may be compared to the overall team's performance for that question. If that individual's performance is substantially below the overall team's performance for that question, the individual may be required to complete training to improve his/her future performance, as measured by that question. As another example, the capabilities of two teams may be compared with one another. If the capabilities of one team in a certain respect exceed the capabilities of another team in the same respect, the former team may be asked to train the latter team. As part of the pattern analysis, trend, graphs or charts may be plotted, as further described below.

Lastly, results (e.g., appraisal information tabulated, plotted, and organized/presented via other ways) may be shared with the scrum team (step 15). Team scores and analysis may be shared with the team while maintaining anonymity of the feedback (e.g., the identity of an evaluator may be kept confidential). The strengths and weaknesses of the team revealed by certain questions may be debated, and ways to improve the performance of the team may be proposed. Individual scores may be shared with a concerned person (i.e., evaluatee) and allow the concerned person to have an open discussion with one or more team members (i.e., evaluators) to bridge any perception gap. A manager (e.g., scrum master, product owner, or an individual outside of the team, people manager) may be involved to mediate the discussion, if mutual agreement between two team members cannot be established.

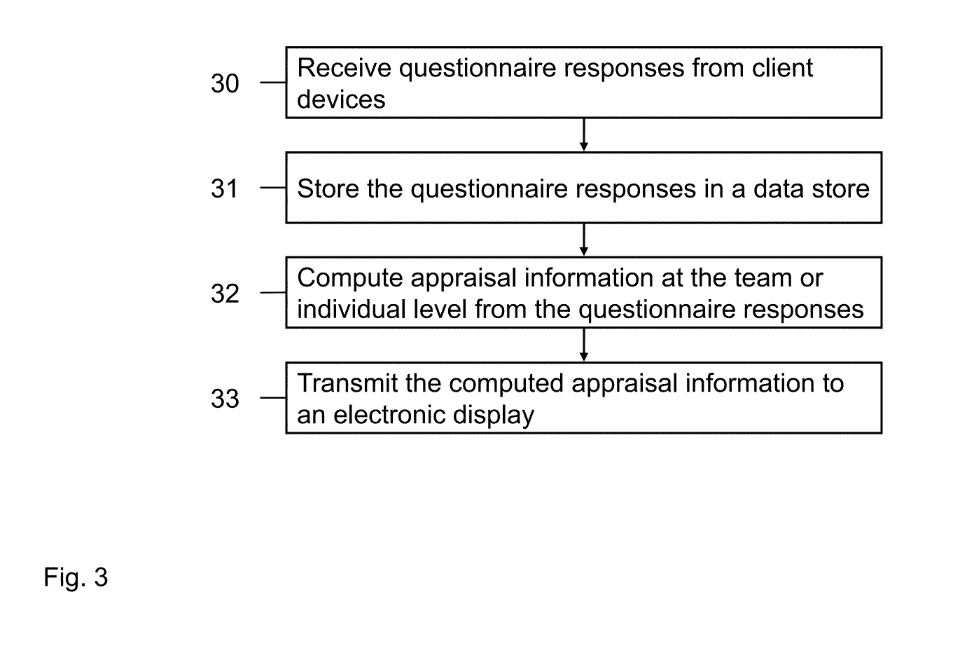

FIG. 3 depicts an exemplary embodiment of the appraisal process from the perspective of the server (i.e., depicts steps that may be performed by a server). First, questionnaire responses are received at server 20 from client devices 21 (step 30). The questionnaire responses may then be stored in a data store, either located at the server, or remotely located from the server (step 31). Appraisal information is then computed at the team or individual level from the questionnaire response (step 32). Lastly, the computed appraisal information is transmitted to an electronic display (step 33). Such electronic display may be located at server 20, or remotely at one or more of client devices 21. It is noted that all steps performed by the server (e.g., receiving questionnaire responses, storing questionnaire responses, computing appraisal information, and transmitting appraisal information) may occur automatically, i.e., without the input of a human operator. Therefore, without any human input after the questionnaire responses are received, appraisal information in the form of tables, graphs, etc. may automatically be generated by server 20. Alternatively, input from a human operator may be accepted by server 20, such as input to select specific appraisal information to be generated.

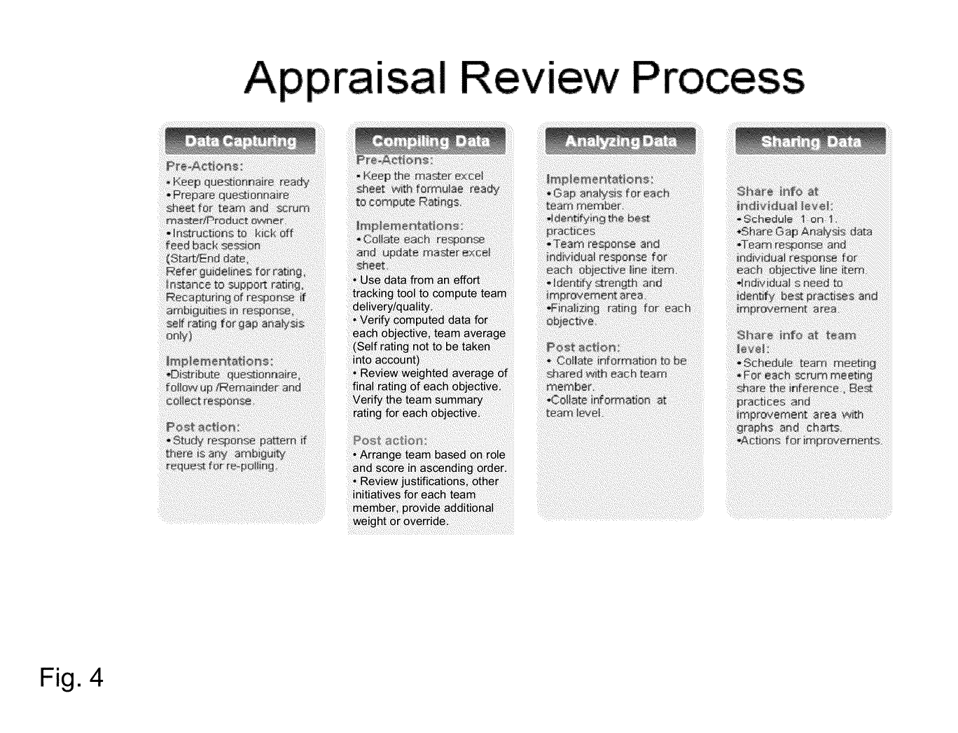

FIG. 4 provides further details concerning an appraisal review process, in accordance with an exemplary embodiment. In a “data capturing” step, certain pre-actions may be performed (e.g., keeping questionnaire ready; preparing questionnaire for team, scrum master and product owner; preparing instructions to “kick off” feedback session—Start/End date, Refer guidelines for rating, instance to support rating, recapturing of response if there are ambiguities in response, self rating for gap analysis only) and certain post-actions may be performed (e.g., studying response pattern if there is any ambiguity, and fulfilling a request for re-polling). The data capturing may be implemented by distributing questionnaires, following up with any reminders, and finally collecting questionnaire responses.

In a “compiling data” step, certain pre-actions may be performed (e.g., keeping a master excel sheet with formulae ready to compute ratings) and certain post-actions may be performed (e.g., arranging team based on role and score in ascending order, reviewing the justifications and/or other initiatives for each team member, providing additional weight and/or override). The compiling data step may be implemented by collating each response and updating a master excel sheet, using data of an effort tracking tool to compute team delivery and quality, verifying computed data for each objective, team average (e.g., team average may not include self rating), reviewing a weighted average of a final rating of each objective, and verifying the team summary rating for each objective.

In an “analyzing data” step, certain post-actions may be performed (e.g., collating information to be shared with each team member, collating information at the team level). The analyzing data step may be implemented by performing a gap analysis for each team member, identifying the best practices, comparing team responses and individual responses for each objective line item, identifying strengths and improvement areas, and finalizing ratings for each objective.

In a “sharing data” step, information may be shared at the individual level during 1-on-1 meetings. During the meeting, gap analysis data may be shared, the team response and individual response for each objective line item may be discussed, and individuals may be requested to identify best practices and improvement areas. Finally, information may also be shared at the team level during a team meeting. During the meeting, inferences, best practices and improvement areas (e.g., identified via graphs and charts) may be shared. Also, specific actions may be discussed to improve the team's performance.

To facilitate the discussion of the appraisal process, a mathematical framework is now provided in association with question responses and the analysis thereof. As mentioned above, responses to questions may be provided as numerical values (e.g., 1, 2, . . . , 9, 10). If responses to questions are provided in words (e.g., unsatisfactory, needs improvement, meets expectations, exceeds expectations, exemplary), such evaluative phrases and/or descriptive words may be mapped into numerical values (e.g., unsatisfactory=1, needs improvement=2, meets expectations=3, exceeds expectations=4, exemplary=5). Words mapped into numerical values and/or a numerical response may be referred to as a score or rating.

A certain score may be that provided by evaluator j, as an evaluation of evaluatee k, for question i. Such score will be denoted by variable s_{i,j,k}, for purposes of discussion. Further, it is assumed there are u questions, such that i takes on values 1, 2, . . . , u−1, u. In addition, it is assumed there are v team members (e.g., scrum team members), such that j and k take on values from 1 up to v. In the typical scenario, j and k take on values from 1, 2, . . . , v−1, v, such that every scrum team member completes a self evaluation and a (peer) evaluation of every other team member. However, this is not necessarily so, and in some instances, a self evaluation may not be completed and/or peer evaluations are completed, but only for a subset of the team members. In the example below, u=5 (i.e., there are 5 questions in the questionnaire), v=7 (i.e., there are 7 scrum team members), and every scrum team member completes a self evaluation and a (peer) evaluation of every other team member.

### Individual Level Analysis:

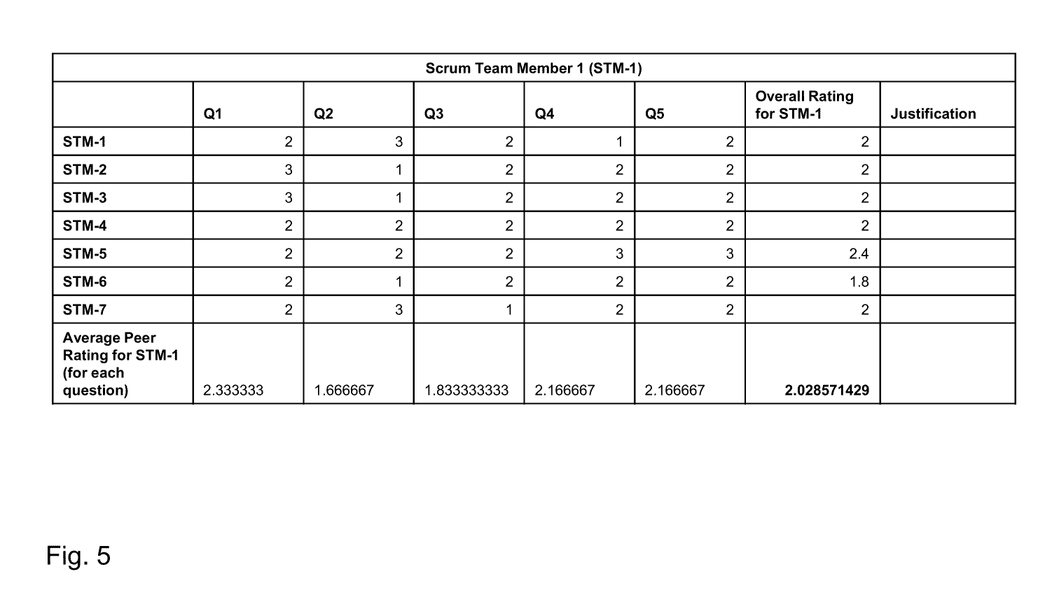

Appraisal information may be analyzed at the individual level. In other words, the focus of any table, plot, or other graphical presentation of appraisal information may be the performance of a single evaluatee, rather than a group of evaluatees. FIG. 5 depicts a table with a certain presentation of self ratings, peer ratings, and other appraisal information concerning scrum team member 1 (STM-1). Entries at row “STM-1” and columns “Q1” through “Q5” (i.e., Q1 abbreviating question number 1 of the questionnaire, Q5 abbreviating question number 5 of the questionnaire) depicts self ratings (e.g., scores 2, 3, 2, 1, 2 provided by STMT) for questions 1 through 5, respectively. Mathematically, these entries correspond to s_{i,1,1}, for i=u. The entry provided at row STM-1 and column “Overall Rating for STM-1” represents self ratings for STM-1 averaged across all questions, which can be computed as

$$\frac{1}{u} {\sum }_{i = 1}^{u} {s}_{i , 1 , 1} .$$

Entries at rows “STM-2” through “STM-7” and columns “Q1” through “Q5” depict peer ratings of STM-1 for questions 1 through 5, respectively. Mathematically, these entries correspond to scores, s_{i,j,1} for question i=1 . . . u, evaluator j=1 . . . v, evaluatee 1. The entries at rows “STM-2” through “STM-7” and column “Overall Rating for STM-1” represent the scores provided by evaluators 2 through 7, respectively, averaged across all questions, which can be computed as

$$\frac{1}{u} {\sum }_{i = 1}^{u} {s}_{i , j , 1} ,$$

for j=2 . . . 7.

Entries at row “Average Peer Rating for STM-1” and columns “Q1” through “Q5” depict the peer ratings of evaluatee 1 for questions 1 through 5, averaged over all peer evaluators, hereinafter also referred to as an “average peer rating”. Mathematically, such entries may be computed as

$$\frac{1}{v - 1} {\sum }_{j = 2}^{v} {s}_{i , j , 1} ,$$

for i=1 . . . 5.

The entry at row “Average Peer Rating for STM-1” and column “Overall Rating for STM-1” corresponds to the score of evaluatee 1, averaged over all questions and evaluators (including self evaluation). Mathematically, this cell may be computed as

$$\frac{1}{uv} {\sum }_{j = 1}^{v} {\sum }_{i = 1}^{u} {s}_{i , j , 1} .$$

While scores associated with evaluatee 1 are depicted in FIG. 5, and have been discussed above, scores associated with other evaluatees (i.e., 2 . . . v) may similarly be depicted and/or organized in other tables, and the above described computations may be modified for these other evaluatees. Additionally, while the scores associated with evaluatee 1 have been organized in a particular fashion in the table depicted in FIG. 5, such organization is merely exemplary, and other organizations are possible. For example, the tables of scores may be transposed, such that each column corresponds to a scrum team member (i.e., evaluator), and each row corresponds to a question of the questionnaire.

In another embodiment, weighted averages may be computed, instead of the unweighted averages described above. In a general framework, a weight w_{i,j,k} may be associated with each score s_{i,j,k}, and each score may be multiplied by its associated weight, before the weighted scores are averaged together. For example, a weighted average of self ratings for STM-1 across all questions, can be computed as

$$\frac{1}{u} {\sum }_{i = 1}^{u} {w}_{i , 1 , 1} , {s}_{i , 1 , 1} .$$

Other expressions presented above for computing averages may be modified to compute weighted averages in a similar manner.

In a typical weighted average, there may be some variation among weights w_{i,j,k}. For example, variation in weights may help capture the differing importance of questions. For example, if question 1 were to evaluate the confidence exhibited an employee, question 2 were to evaluate the enthusiasm exhibited by an employee, and confidence were considered more important than enthusiasm, then w_{i,2,k} may be greater than w_{i,3,k}. As another example, variation in weights may help capture the differing importance of evaluators. For example, a certain organization may value the input of a scrum master more than the input of a development team member. If, say, employee 2 were a scrum master and employee 3 were a development team member, then for that organization, w_{i,2,k} may be greater than W_{i,3,k}. Likewise, variation in weights may help capture the differing importance of evaluatees. For example, a certain organization may value software developers more than software testers. If, say, employee 1 were a software developer, an employee 2 were a software tester, w_{i,j,1} may be greater than w_{i,j,2}.

The weights associated with the scores discussed so far (e.g., subjective scores measuring an individual's behavior) may also help to bridge the above-described metrics (e.g., objective metrics measuring an individual's productivity) with the scores. For example, if question 3 concerns an employee's peers impression of his/her dedication, and there is a related objective metric to question 3, such as the number of annual hours worked by the employee, the weight associated with question 3 may account for such an objective metric.

In general, weights may be integer numbers (including or excluding negative values), real numbers, real numbers between 0 and 1, or real numbers between −1 and 1. Negative weights may be used in the instance that a behavior is considered to be a negative behavior, such as lack of confidence or lack of enthusiasm.

Other weighting schemes are possible. For example, weights may be assigned to eliminate outlier scores. For example, the highest 2 scores and the lowest 2 scores may be eliminated by setting their associated weights to 0.

### Individual Level Analysis—Perception Gaps

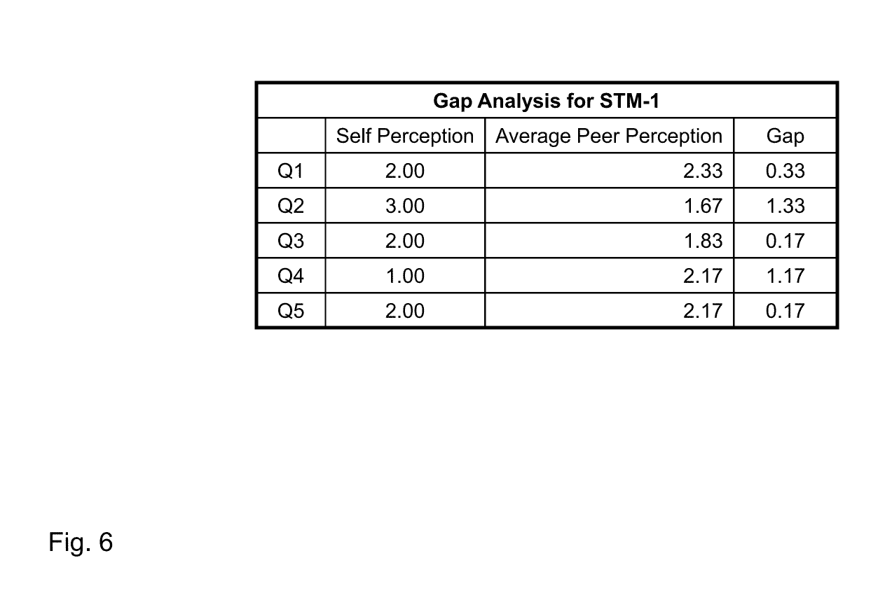

In another embodiment, the difference (i.e., gap in perception) between self ratings and average peer ratings may be computed for each question. For illustration purposes, the perception gap for STM-1 has been computed for each question. In the table depicted in FIG. 6, self ratings are tabulated under the column “Self Perception”, average peer ratings are tabulated under the column “Average Peer Perception”, and perception gaps are tabulated under the column “Gap”. Mathematically, the perception gap associated with STM-1 can be computed as

$$\vert {s}_{i , 1 , 1} - \frac{1}{v - 1} {\sum }_{j = 2}^{v} {s}_{i , j , 1} \vert ,$$

for questions i=1 . . . 5. While this expression, as well as the values in the “Gap” column depicted in FIG. 6 represent an absolute difference (i.e., that using an absolute value operation), the absolute value operation is optional. If the absolute value were omitted, a positive perception gap may indicate an inflated self perception, relative to the average peer perception, whereas a negative perception gap may indicate a deflated self perception, relative to the average peer perception.

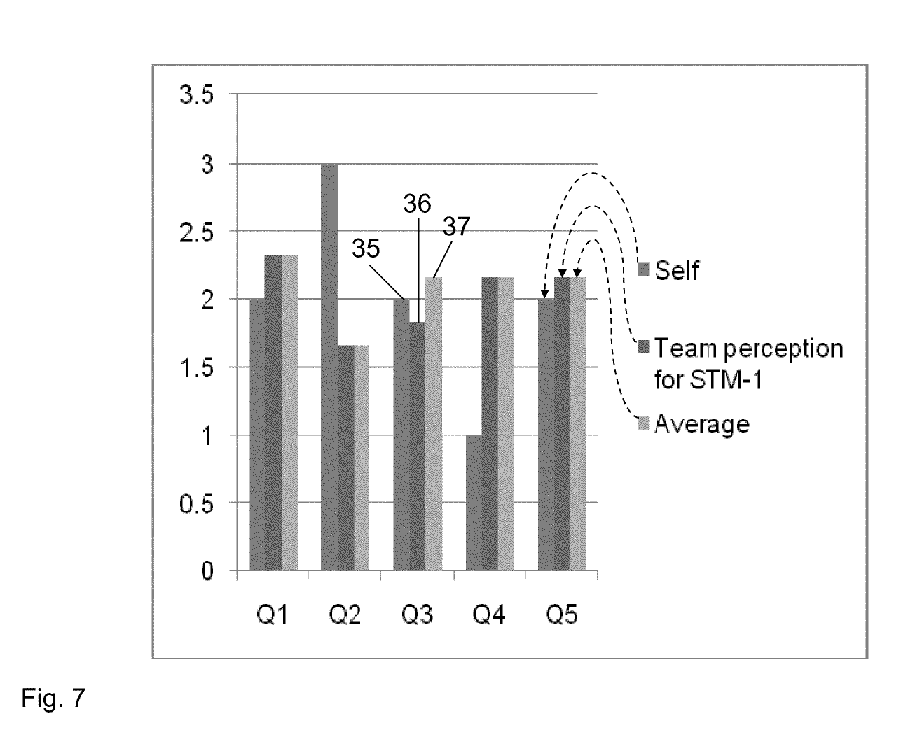

The perception gap may also be visually presented in the form of a bar chart, such as that depicted in FIG. 7. In FIG. 7, the first bar 35 and second bar 36 depicted for each question represents a self rating and an average peer rating for STM-1, respectively. A gap (i.e., a difference in height) between the first and second bars may visually represent the perception gap for a particular question. The third bar 37 represents the average team score for a particular question, computed for question i as

$$\frac{1}{{v}^{2}} {\sum }_{j = 1}^{v} {\sum }_{k = 1}^{v} {s}_{i , j , k}$$

(i.e., a score representing the average performance of an entire team). Comparison of the first and/or second bars with the third bar reveals the performance of an individual relative to the average performance of the team.

While not depicted in FIGS. 6 and 7, any question having a perception gap exceeding a certain value may be automatically flagged (e.g., bolded, circled, presented in red, etc.) Also, any question having a perception gap exceeding a certain value may trigger certain other actions to occur. For example, a question having a perception gap exceeding a certain value may trigger all illustrative examples (associated with that question) provided by the evaluators and/or evaluatee (in the case of the self evaluation) to be compiled together and displayed. Alternatively and/or in addition, a question having a perception gap exceeding a certain value may trigger an e-mail to be automatically sent to the evaluatee notifying the evaluatee of the perception gap associated with that question. Upon receiving such e-mail, the evaluatee may be presented with the opportunity to explain the cause of the perception gap. In a question that evaluates productivity, perhaps the evaluatee was highly productive during a sprint (and as a result gave himself/herself high ratings associated with that question), but worked from home due to an illness (causing his/her peers to provide low ratings associated his/her productivity). An explanation (e.g., incorrect perception of productivity due to working remotely) may be provided by the employee, in the form of a reply e-mail. Discussion of a perception gap associated with a question need not occur via e-mail, and may be facilitated via other electronic communication channels, such as videoconferencing. In addition, discussion of a perception gap may take place via a face-to-face meeting between various team members (e.g., scrum team members).

Of course, there may be questions in which there is no perception gap. Such questions may unambiguously reveal strengths and weaknesses of the employee (e.g., scrum team member). A question having a high score in both the self evaluation and peer evaluation may reveal strengths associated with an employee. Likewise, a question having a low score in both the self evaluation and peer evaluation may reveal a weakness associated with an employee. A question revealing strengths of an employee may prompt the employee to share his/her insights with other employees. For example, if, say, a Toastmasters class helped an employee cultivate good presentation skills, the employee can advise his/her peers to also take a Toastmasters class. A question revealing a weakness of an employee may prompt an employee to seek guidance from other employees (e.g., other scrum team members) to enhance his/her skills. For example, a question revealing that an employee tends to ignore the input of others can prompt the employee to discuss such issues with his/her team. Perhaps, the goals of the employee and that of his/her team are not aligned.

Further, the presentation of the perception gap in tabular form (FIG. 6) and in a bar chart (FIG. 7) are examples only, and other presentation of the perception gap are contemplated, such as a scatter plot of self and average peer ratings versus question number.

### Team Level Analysis:

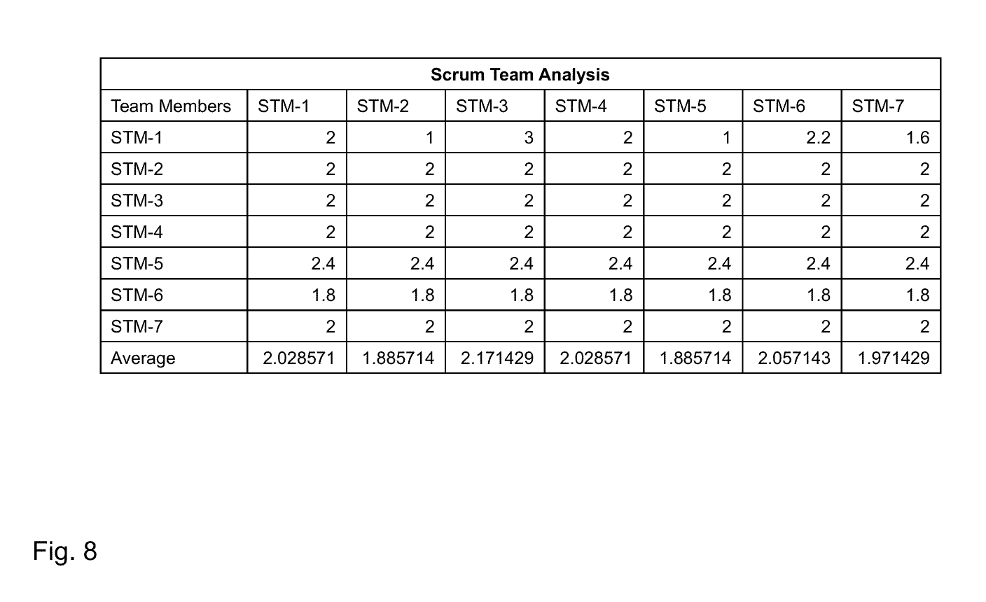

In another embodiment, questionnaire responses can be analyzed and displayed at the team level, which allows for convenient comparison of the performance of one evaluatee relative to the performance of another evaluatee and/or convenient comparison of average scores provided by one evaluator relative to the average scores provided by another evaluator. Stated differently, the focus of any table, plot, or other graphical presentation of appraisal information may be the respective and/or combined performance of a group of evaluatees, rather than that of a single evaluatee. For example, FIG. 8 depicts a table, titled “Scrum Team Analysis”, which presents appraisal information (e.g., average scores) for multiple evaluatees (i.e., STM-1 through STM-7) averaged across all questions. Each row labeled STM-1 . . . STM-7 indicates an evaluator, and each column labeled STM-1 . . . STM-7 indicates an evaluatee. The entry (i.e., cell) at row “STM-j”, column “STM-k” of the table corresponds to the score assigned to evaluatee k by evaluator j, averaged over all the questions, and may be computed as

$$\frac{1}{u} {\sum }_{i = 1}^{u} {s}_{i , j , k} ,$$

for j=1 . . . v and k=1 . . . v. Therefore, cells at diagonal positions of the table correspond to average self ratings, whereas cells at off-diagonal positions of the table correspond to ratings from one peer evaluator averaged over all questions. For example, the cell at row STM-1, column STM-1 corresponds to the average self ratings of STM-1, and the cell at row STM-2, column STM-1 corresponds to the average peer rating of evaluatee 1 by evaluator 2.

The last row of the table, labeled “Average”, corresponds to the scores of each evaluatee averaged across all evaluators (i.e., the average in the example includes self ratings, but this is not necessarily so) and all questions. Such average score, for each evaluatee STM-k, may computed as

$$\frac{1}{uv} {\sum }_{j = 1}^{v} {\sum }_{i = 1}^{u} {s}_{i , j , k} ,$$

and may provide an overall evaluation of an evaluatee in a single quantitative value.

It can be observed that the column of values under “STM-1” in FIG. 8 (i.e., 2, 2, 2, 2, 2.4, 1.8, 2) is identical to the column of values under “Overall Rating for STM-1” in FIG. 5, as these columns display identical information. Therefore, upon generating tables of appraisal information (i.e., scores) at the individual level for each scrum team member (i.e., similar to the table depicted in FIG. 5 for STM-1, but for all other scrum team members), it is possible to generate the table of appraisal information at the team level, as depicted in FIG. 8, by collating the columns “Overall Rating for STM-1”, “Overall Rating for STM-2” . . . , “Overall Rating for STM-7” from the respective tables of appraisal information at the individual level for each scrum team member.

As may be already apparent, in the table depicted in FIG. 8, each column of values corresponds to average scores measuring the performance of a particular evaluatee, as provided by various evaluators. In contrast, each row of values corresponds to average scores provided by a particular evaluator for various evaluatees. Therefore, to compare the performance of two or more of the evaluatees, it is possible to compare two and more columns of the table depicted in FIG. 8. For example, one comparing the performance of STM-2 versus the performance of STM-3 will notice that these evaluatees received identical average scores from all team members, except for STM-1, which provided higher average scores to STM-3 (i.e., 3) than STM-2 (i.e., 1). A visual comparison of the performance of two or more of the evaluatees may be automatically (or manually) generated from two or more columns of the table depicted in FIG. 8. Such visual comparison may include a bar chart, line chart, and the like.

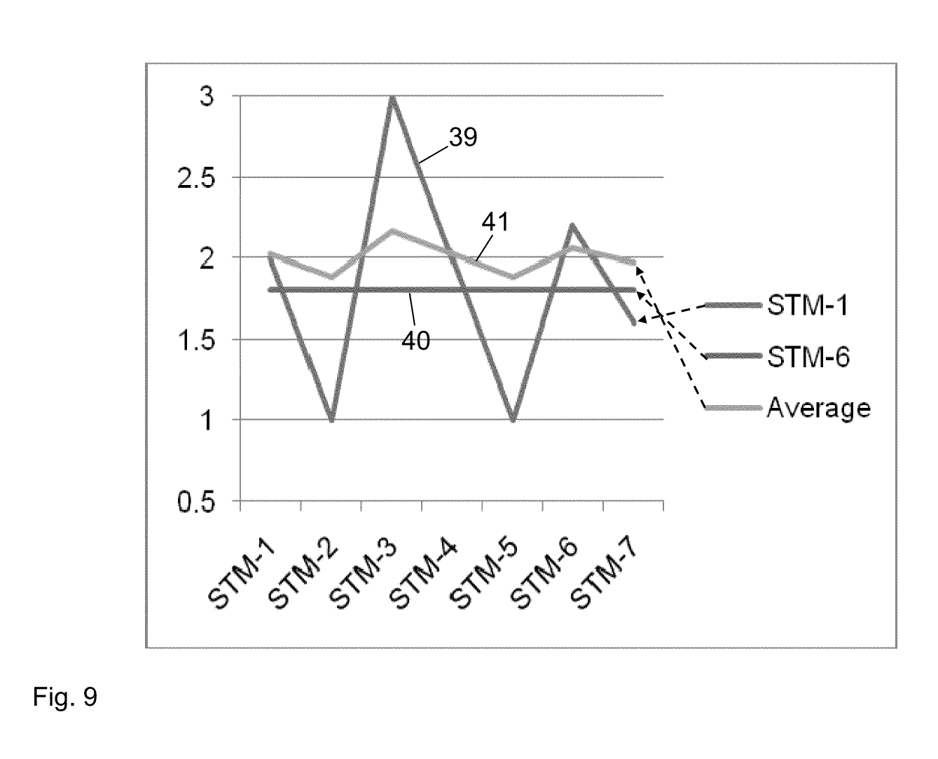

To compare the average scores provided by two or more evaluatees, it is possible to compare two or more rows of the table depicted in FIG. 8. For example, one comparing the average scores provided by STM-5 versus STM-6 will notice that STM-5 provided higher average scores to all evaluatees (i.e., 2.4) than STM-6 (i.e., 1.8). Likewise, a visual comparison of the average scores provided by two or more evaluators may be automatically (or manually) generated from two or more rows of the table depicted in FIG. 8. Such visual comparison may include a bar chart, line chart, and the like. For example, FIG. 9 depicts a line chart comparing the average scores provided by evaluators STM-1 and STM-6, for evaluatees STM-1 . . . STM-7. (The average scores provided by evaluators STM-1 and STM-6 are indicated by reference numbers 39 and 40, respectively.) The line chart also includes average scores (reference number 41) provided for evaluatees STM-1 . . . STM-7, averaged across all evaluators (including self evaluation) and averaged across all questions.

It is also contemplated that scores provided by each evaluator (i.e., each row corresponding to STM-1, STM-2, etc. in FIG. 8) may be first normalized, before averaged ratings (i.e., last row of table in FIG. 8) are computed. For example, each row corresponding to STM-1, STM-2, etc. may be viewed as a vector (i.e., v), and one way to normalize each row would be to replace each vector with its unit vector (i.e., v/∥v∥). Computing a unit vector is merely exemplary, and other normalization computations are possible. Normalizing scores from each evaluator ensures that each evaluator has an equal say in an evaluatee's average score (i.e., that averaged across all evaluators) and prevents a single evaluator from “hijacking” or skewing an evaluatee's average score. Normalization, however, is not always desirable, as in the trend analysis described below, in which normalization may preclude a trend from being observed.

While the above-described averages for the team level analysis have been unweighted averages, it is possible to use weighted averages instead. Weighted averages for the team level analysis may be computed in a similar manner to the weighted averages for the individual level analysis.

It is also contemplated to generate a different table of appraisal information by collating the last row “Average Peer Rating for STM-1”, “Average Peer Rating for STM-2” . . . , “Average Peer Rating for STM-3” from the respective tables of appraisal information at the individual level for each scrum team member. Such table would help compare average peer ratings of each evaluatee across the different questions.

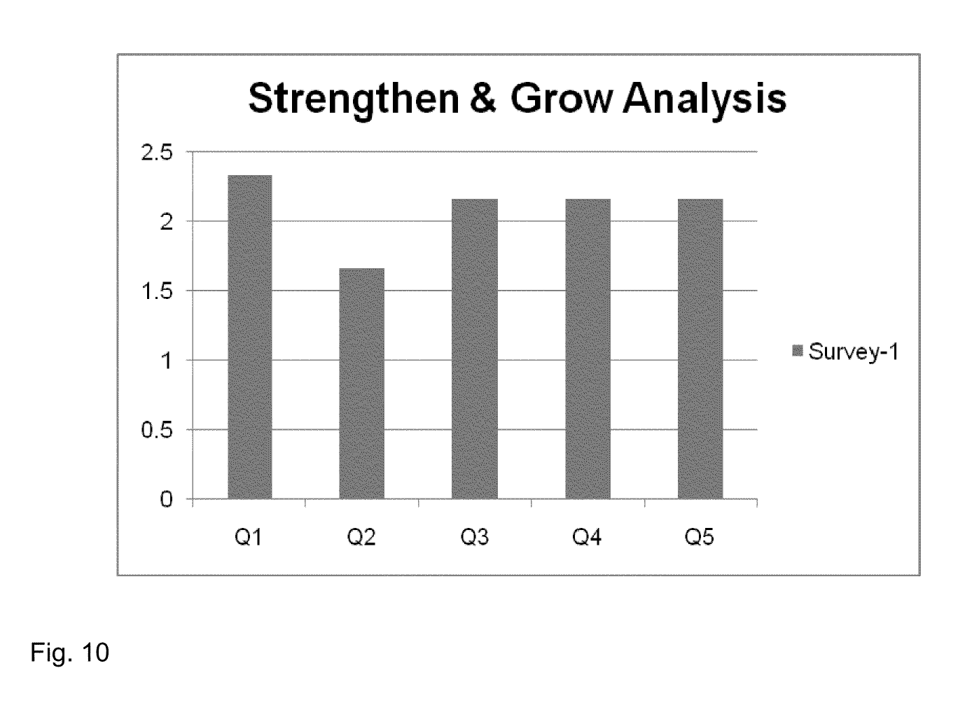

The “Strengthen & Grow Analysis” bar chart depicted in FIG. 10 is yet another way to present appraisal information at the team level. In the bar chart, an overall team rating is depicted for each question. For question i, such overall team rating may be computed as

$$\frac{1}{{v}^{2}} {\sum }_{j = 1}^{v} {\sum }_{k = 1}^{v} {s}_{i , j , k} ,$$

and represents the score for question i, averaged over all evaluator—evaluatee pairs (j, k), j=1 . . . v and k=1 . . . v. Such bar chart may be very convenient for resource managers to study the team behavior (e.g., scrum team behavior) and identify the strengths and areas in need of improvement for the team (e.g., scrum team). Such bar chart may also be helpful for initiating programs to enhance team capabilities. For example, the lower score corresponding to question 2 may prompt a manager to provide training (e.g., training via written materials, presentation) to the team so as to increase the team's capability with respect to the behavior measured by question 2.

### Team Level Analysis—Trend Analysis

So far, only one questionnaire has been discussed. However, it is also contemplated that a series of questionnaires be conducted over time to measure/evaluate the temporal change in performance of an individual/team.

With a series of questionnaires, the above-described mathematical framework may need to be adjusted to account for the extra dimension of questionnaire number. For example, in a new mathematical framework, score s_{i,j,k,l} may represent the score collected during questionnaire number l, for question i, from evaluator j, for evaluatee k. In the example below, four questionnaires have been conducted.

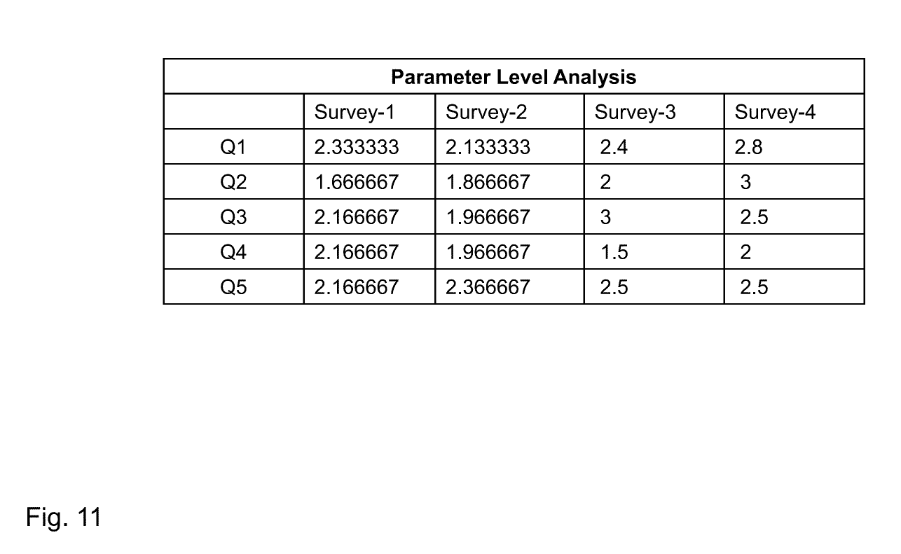

In the table, titled “Parameter level Analysis”, as depicted in FIG. 11, the column “Survey-1” holds the overall team ratings, for each question (i.e., scores averaged over all evaluator—evaluatee pairs) for questionnaire 1. In light of the new mathematical framework, such overall team ratings may be computed as

$$\frac{1}{{v}^{2}} {\sum }_{j = 1}^{v} {\sum }_{k = 1}^{v} {s}_{i , j , k , 1}$$

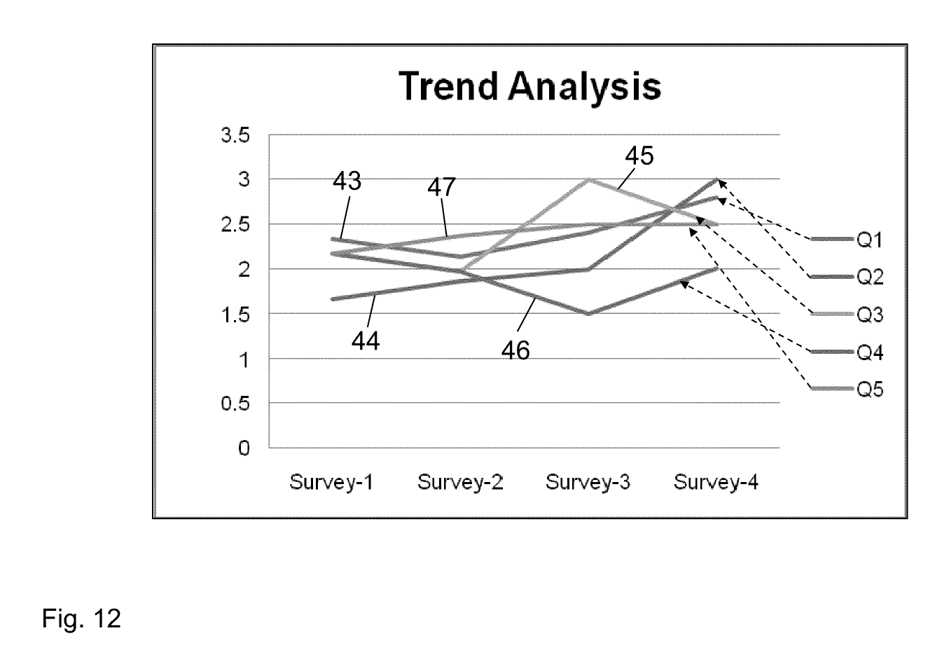

for questions i=1 . . . 5. Other columns of the table depict similar average scores, except collected from different questionnaires. Row “Q1” captures the team's trend (i.e., time evolution) in performance related to question 1. For question 1, it appears the team's performance is improving (i.e., with a starting value of 2.33 in questionnaire 1 and an ending value of 2.8 in questionnaire 4). In contrast, for question 4, it appears the team's performance is degrading (i.e., with the starting value of 2.16 in questionnaire 1 and an ending value of 2 in questionnaire 4). Such trends may be displayed in a common line plot, such as, for example, the “Trend Analysis” line plot depicted in FIG. 12. In the “Trend Analysis” line plot, the “Q1” line (indicated by reference number 43) depicts the team's trend in performance for question 1; the “Q2” line (indicated by reference number 44) depicts the team's trend in performance for question 2; the “Q3” line (indicated by reference number 45) depicts the team's trend in performance for question 3; the “Q4” line (indicated by reference number 46) depicts the team's trend in performance for question 4; and the “Q5” line (indicated by reference number 47) depicts the team's trend in performance for question 5.

### Sample Dashboards

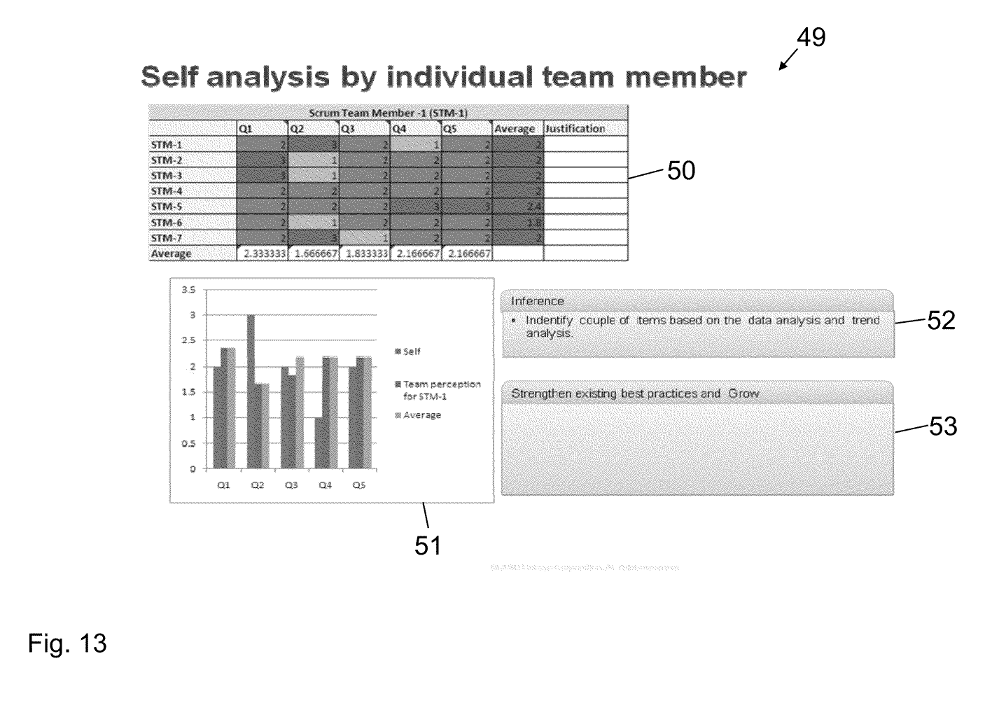

The tables and plots discussed in association with the individual level analysis may be displayed together in an “Individual Level Analysis Dashboard”. FIG. 13 depicts an example dashboard 49 with the above-described table of appraisal information for STM-1 50 and the above-described bar chart 51 contrasting self perception versus team perception of performance (the bar chart also contrasting self performance with team performance). The dashboard also includes one or more automatically (or manually) generated comment boxes. For example, a comment box titled “Inference” 52 could provide inferences pertaining to an individual's performance that can be made from the collected questionnaire responses. For example, if the self rating of an evaluatee consistently exceeds the average peer rating of the evaluatee, the comment box could have a comment stating “scrum team member has an inflated perception of self”. As another example, a comment box titled “Strengthen existing best practices and Grow” 53, could provide steps that can be taken for an individual to strengthen existing best practices as well as for the individual to acquire new skills. For example, if the individual received low scores regarding presentation skills, the comment box may suggest the individual to enroll in a Toastmasters class. Of course, such “Individual Level Analysis Dashboard” is merely exemplary, and various tables, plots, comment boxes may be added and/or deleted, and their positions with respect to one another varied from that depicted in FIG. 13.

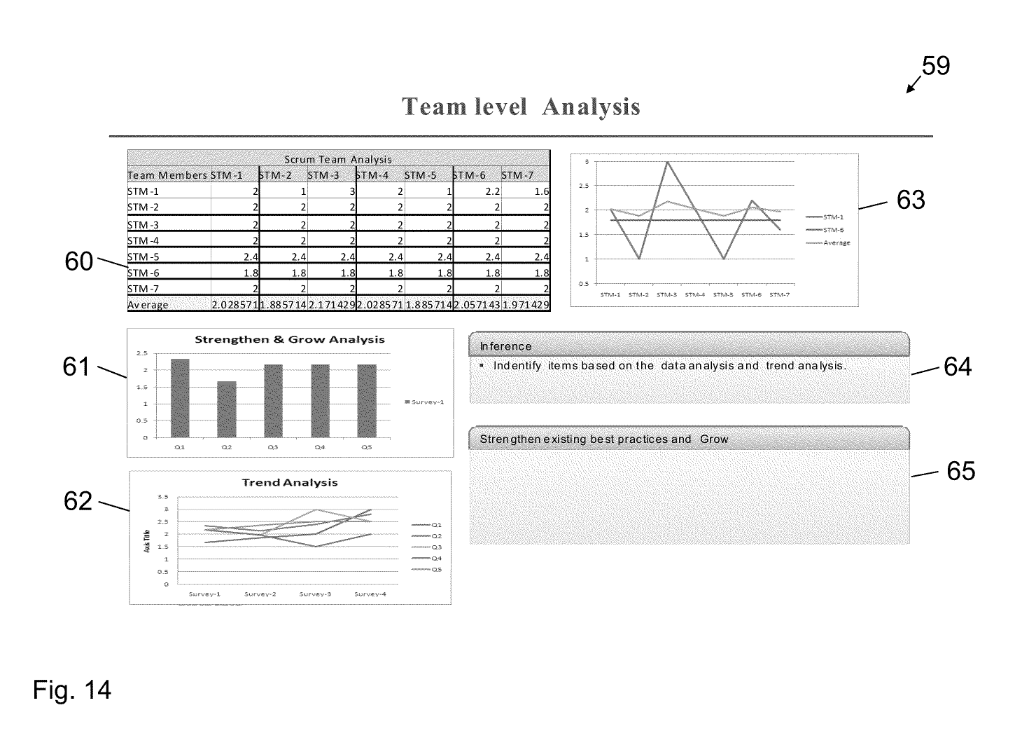

Likewise, the tables and plots discussed in association with the team level analysis may be displayed together in a “Team Level Analysis Dashboard”. FIG. 14 depicts a dashboard 59 with the above-described “Scrum Team Analysis” table 60, “Strengthen & Grow Analysis” table 61, “Trend Analysis” line plot 62, and line plot 63 comparing the average scores provided by certain evaluators. Similar to the “Individual Level Analysis Dashboard”, the “Team Level Analysis Dashboard” may have one or more automatically (or manually) generated comment boxes (64, 65). Of course, such “Team Level Analysis Dashboard” is merely exemplary, and various tables, plots, comment boxes may be added and/or deleted, and their positions with respect to one another varied from that depicted in FIG. 14.

While the discussion so far has only addressed one team (e.g., scrum team), it is also contemplated that such a performance evaluation framework may be applied to an organization with multiple teams. If there are multiple teams, one team may evaluate another team. For the sake of discussion, suppose there are two teams: team A and team B. In the scenario that team A evaluates team B, the evaluation framework is quite similar to that discussed above, except that evaluators from team A also evaluate team B (i.e., team B as a whole). It is also contemplated that evaluators from team A may evaluate individual members from team B. In such an evaluation framework, it is possible to compare the performance of one team with respect to another team.

For instance, say the “Strengthen & Grow Analysis” depicted in FIG. 10 corresponded to team A's evaluation of team A, and a similar plot were generated, except corresponding to team B's average evaluation of team A. A comparison of these two plots would yield the perception gap by one team relative to another team. For example, team A may believe that its team has a high degree of collaboration, while team B may believe otherwise. Such cross-team perception gap would be revealed by such a cross-team evaluation framework.

As another example, suppose the “Strengthen & Grow Analysis” depicted in FIG. 10 corresponded to team A's evaluation of team A, and a similar plot were generated, except corresponding to team B's evaluation of team B. A comparison between these two plots would yield a comparison of the performance of the two respective teams. For example, through such an analysis, it may be determined that team A perceives itself to have a low degree of collaboration, while team B perceives itself to have a high degree of collaboration. Assuming that the intra-team perception/evaluation is accurate, it may be suggested for team B to coach team A members on how to better collaborate with one another.

### Some Observations on Appraisal Framework

Comments, provided by team members illustrating the instances in which a behavior was demonstrated or not demonstrated, may be very useful feedback for the team member concerned. Such comments may be important, as a focus of the performance review may include dialogue on the performance and not just computing an evaluation rating. As the team member receiving the feedback is able to relate to the pattern of instances (e.g., scores, ratings) during the one-on-one discussion, the feedback may be received in a less defensive way. Importantly, the system may bring out the silent contributors who contribute to the team in a significant way, but stay away from limelight. Lastly, the patterns (e.g., patterns of scores, ratings) may also be very good indicators of the internal workings of a team, which cannot be brought out as clearly by solely relying on other mechanisms such as meetings.

### Conclusion/Benefits

Systems and methods described herein attempt to provide a more transparent appraisal system, in which appraisal information (e.g., feedback, ratings, scores, and aggregated versions thereof) may represent an aggregated opinion of the people who work together. It is a more democratic process, as opposed to previous methods of performance review in which a manager dictates most of an employee's evaluation. Employee satisfaction in the performance appraisal system described herein can be achieved due to a more defined framework for performance evaluation.

Further Details about Implementation

In implementing these systems and methods to be performed by a suitably programmed computer, it is intended that the computer have a processor and a computer readable medium, wherein the computer readable medium has program code. The program code can be made of one or more modules that carry out instructions for implementing the systems and methods herein. The processor can execute the instructions as programmed in the modules of the program code. For example, the processor can execute instructions for determining, calculating, assigning, obtaining, converting, computing, and variations thereof.

The systems and methods described can be implemented as a computer program product having a tangible computer readable medium having a computer readable program code embodied therein, the computer readable program code adapted to be executed to implement a method for performing the methods described above. Each step or aspect can be performed by a different module, or a single module can perform more than a single step.

The systems and methods described herein as software can be executed on at least one server, though it is understood that they can be configured in other ways and retain its functionality. The above-described technology can be implemented on known devices such as a personal computer, a special purpose computer, cellular telephone, personal digital assistant (PDA), a programmed microprocessor or microcontroller and peripheral integrated circuit element(s), and ASIC or other integrated circuit, a digital signal processor, a hard-wired electronic or logic circuit such as a discrete element circuit, a programmable logic device such as a PLD, PLA, FPGA, PAL, or the like. In general, any device capable of implementing the processes described herein can be used to implement the systems and techniques according to this invention.

It is to be appreciated that the various components of the technology can be located at distant portions of a distributed network and/or the Internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

Moreover, the disclosed methods may be readily implemented in software, e.g., as a computer program product having one or more modules each adapted for one or more functions of the software, executed on a programmed general purpose computer, cellular telephone, PDA, a special purpose computer, a microprocessor, or the like. In these instances, the systems and methods of this invention can be implemented as a program embedded on a personal computer such as a JAVA®, CGI or Perl script, as a resource residing on a server or graphics workstation, as a routine embedded in a dedicated image system, or the like. The systems and methods of this invention can also be implemented by physically incorporating this system and method into a software and/or hardware system, such as the hardware and software systems of a computer. Such computer program products and systems can be distributed and employ a client-server architecture.

### Block Diagram of Computer System

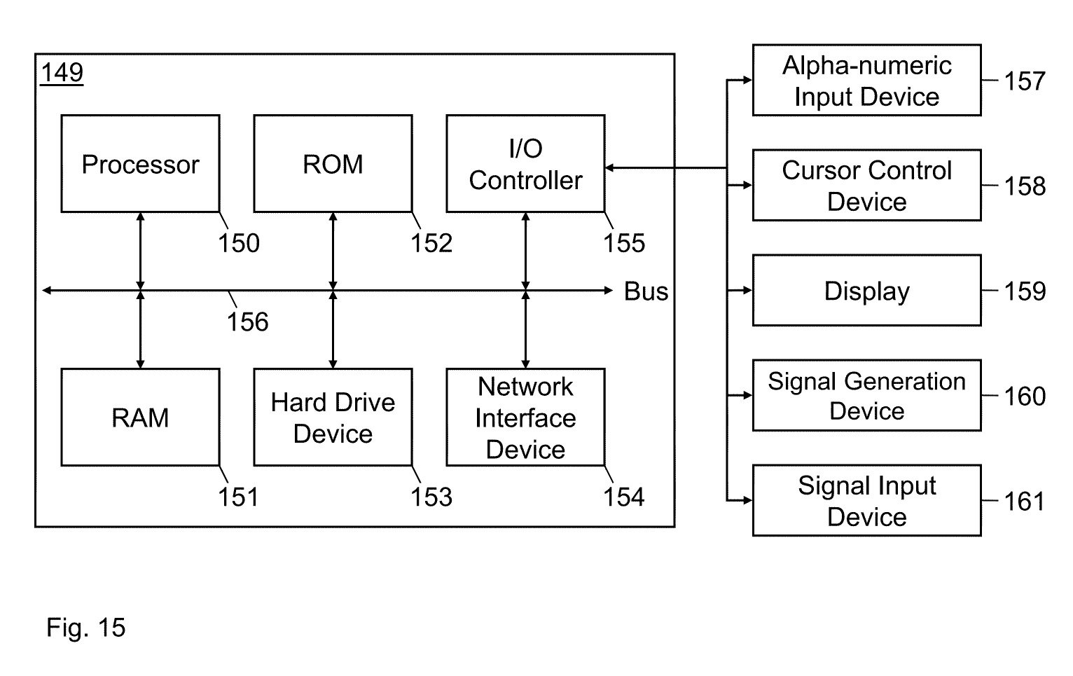

FIG. 15 of the accompanying drawings illustrates computer system 149, also known as a data processing system. The operations, processes, modules, methods, and systems described and shown in the accompanying figures of this disclosure are intended to operate on one or more computer systems as sets of instructions (e.g., software), also known as computer-implemented methods. The computer system depicted in FIG. 15 is generally representative of any client computing device, server computing device and/or mobile device (e.g., a mobile cellular device, Personal Digital Assistant (PDA), satellite phone, mobile Voice over Internet Protocol (VoIP) device, iPhone®, iPad®). Computer system 149 includes at least one processor 150 (e.g., a Central Processing Unit (CPU), a Graphics Processing Unit (GPU) or both), Random Access Memory (RAM) 151 (e.g., flash memory, Dynamic Random Access Memory (DRAM), Static Random Access Memory (SRAM), Synchronous DRAM (SDRAM), etc.), Read Only Memory (ROM) 152 (e.g., Erasable Programmable Read Only Memory (EPROM), Electrically Erasable Programmable Read Only Memory (EEPROM)), hard drive device 153 whether built-in, internal, external and/or removable (e.g., USB device, magnetic storage device, optical storage device, compact disk (CD) read/write device, digital video disk (DVD) read/write device, floppy disk read/write device, etc.), a network interface device 154, and input/output (I/O) controller 155, which are communicatively coupled with one another other via one or more busses 156.

I/O controller 155 may interface computer system 149 with alpha-numeric input device 157 (e.g., a keyboard, phone pad, touch screen), cursor control device 158 (e.g., a mouse, joy-stick, touch-pad), display 159 (e.g., Liquid Crystal Display (LCD), a Cathode Ray Tube (CRT) or a touch screen), signal generation device 160 (e.g., a speaker, ear buds, a headset), and signal input device 161 (e.g., a microphone, camera, fingerprint scanner, web-cam).

Network interface device 154 may include, for example, a network interface card (NIC), Ethernet card, and/or dial-up modem, and may be communicatively coupled to a network (not depicted). In addition, the network interface device may be a wireless network interface device in the case of mobile device communicatively coupled to a network (e.g., a cellular, VoIP and/or WiFi network). If computer system 149 is server, alpha-numeric input device 157, cursor control device 158, display 159, signal generation device 160 and/or signal input device 161 may be omitted.

One or more of ROM 152, RAM 151, and hard drive device 153 includes a computer-readable storage medium on which is stored one or more sets of computer-readable instructions (e.g. software) embodying one or more of the operations described herein. The computer-readable storage medium may include a single medium or multiple media (e.g., a centralized or distributed database, and/or associated caches and servers) that store the one or more sets of computer-readable instructions. The term “computer-readable storage medium” shall also be taken to include any physical/tangible medium that is capable of storing or encoding a set of instructions for execution by a processor.

The embodiments described above are intended to be exemplary. One skilled in the art recognizes that numerous alternative components and embodiments that may be substituted for the particular examples described herein and still fall within the scope of the invention.

What is claimed is:

1. A computer-implemented method for computing appraisal information concerning an individual, the method comprising:
receiving, by a server, questionnaire responses evaluating the individual from a plurality of client devices, the questionnaire responses including (i) self evaluation responses, by the individual, to a plurality of questions and (ii) peer evaluation responses, by peers of the individual, to the plurality of questions;
computing appraisal information from the questionnaire responses, by:
(i) for each question, computing an aggregate peer evaluation from peer evaluation responses corresponding to that question; and
(ii) for each question, computing a metric indicative of a discrepancy between a self perception of the individual's performance as indicated in the self evaluation response corresponding to that question and a peer perception of the individual's performance as indicated in the aggregate peer evaluation corresponding to that question, the appraisal information including the computed metric; and
initiating the computed appraisal information to be transmitted from the server to an electronic display device.

2. The computer-implemented method according to claim 1, wherein the aggregate peer evaluation comprises an average of peer evaluation responses corresponding to a common question.

3. The computer-implemented method according to claim 1, further comprising determining whether the computed metric exceeds a threshold, and if so, alerting the individual of a perception gap associated with a corresponding question.

4. The computer-implemented method according to claim 3, wherein a positive value associated with the perception gap indicates an inflated self perception relative to the peer perception, and a negative value associated with the perception gap indicates a deflated self perception relative to the peer perception.

5. The computer-implemented method according to claim 1, wherein the steps of receiving, storing, computing and initiating occur without any input from a human operator.

6. The computer-implemented method according to claim 1, wherein each questionnaire response evaluates a behavior of the individual.

7. The computer-implemented method according to claim 1, wherein the individual and peers of the individual belong to a scrum team.

8. The computer-implemented method according to claim 1, further computing a quantity representing an evaluation of the individual, by averaging the self evaluation responses.

9. The computer-implemented method according to claim 1, further computing a quantity representing an evaluation of the individual, by averaging peer evaluation responses corresponding to a common peer evaluator.

10. The computer-implemented method according to claim 1, further computing a quantity representing an evaluation of the individual, by averaging all peer evaluation responses and all self evaluation responses.

11. A computer-implemented method for computing appraisal information concerning a first and second individual, the method comprising:
receiving, by a server, questionnaire responses evaluating the first individual and questionnaire responses evaluating the second individual from a plurality of client devices, the questionnaire responses including (i) self evaluation responses, by the first and second individuals, to a plurality of questions and (ii) peer evaluation responses, by peers of the first and second individuals, to the plurality of questions;
computing appraisal information from the questionnaire responses, by:
(i) for each of the first and second individuals, computing an aggregate evaluation from questionnaire responses from a common evaluator; and
(ii) facilitating a comparison between the aggregate evaluation of the first individual and the aggregate evaluation of the second individual, the appraisal information capturing the comparison; and
initiating the computed appraisal information to be transmitted from the server to an electronic display device.

12. The computer-implemented method according to claim 11, wherein the aggregate evaluation comprises an average of peer evaluation responses from a common peer evaluator.

13. The computer-implemented method according to claim 11, wherein the aggregate evaluation comprises an average of self evaluation responses.

14. The computer-implemented method according to claim 11, further computing a quantity representing an evaluation of the first individual, averaged over all evaluators and all questions.

15. The computer-implemented method according to claim 11, further computing a quantity representing an evaluation of a team, the team including the first and second individuals and the peers of the first and second individuals, and the evaluation of the team being averaged over all members of the team and all questions.

16. The computer-implemented method according to claim 15, further comprising conducting a series of questionnaires over time, and computing, from the series of questionnaires, a trend of the team's performance associated with each respective question.

17. The computer-implemented method according to claim 15, wherein the team is a scrum team.

18. The computer-implemented method according to claim 11, wherein each questionnaire response evaluates a behavior of the first or second individual.

19. The computer-implemented method according to claim 11, wherein the steps of receiving, storing, computing and initiating occur without any input from a human operator.

20. A computer-implemented method for computing appraisal information concerning a first team, the method comprising:
receiving, by a server, questionnaire responses evaluating the first team from a plurality of client devices, the questionnaire responses including (i) responses, by the first team, to a plurality of questions and (ii) responses, by a second team different than the first team, to the plurality of questions;
computing appraisal information from the questionnaire responses, by:
(i) for each question, computing an aggregate intra-team evaluation of the first team from responses by the first team corresponding to that question and an aggregate inter-team evaluation of the first team from responses by the second team corresponding to that question; and
(ii) for each question, computing a metric indicative of a discrepancy between an intra-team perception the first team's performance as indicated in the aggregate intra-team evaluation corresponding to that question and an inter-team perception of the first team's performance as indicated in the aggregate inter-team evaluation corresponding to that question, the appraisal information including the computed metric; and
initiating the computed appraisal information to be transmitted from the server to an electronic display device.

21. A computer-implemented method for computing appraisal information concerning a first and second team, the method comprising:
receiving, by a server, questionnaire responses evaluating the first and second teams from a plurality of client devices, the questionnaire responses including (i) responses evaluating the first team, by the first team, to a plurality of questions and (ii) responses evaluating the second team, by the second team, to the plurality of questions;
computing appraisal information from the questionnaire responses, by:
(i) for each question, computing an aggregate intra-team evaluation of the first team from responses by the first team corresponding to that question and an aggregate intra-team evaluation of the second team from responses by the second team corresponding to that question; and
(ii) for each question, computing a metric indicative of a discrepancy between an intra-team perception the first team's performance as indicated in the aggregate intra-team evaluation of the first team corresponding to that question and an intra-team perception of the second team's performance as indicated in the aggregate intra-team evaluation of the second team corresponding to that question, the appraisal information including the computed metric; and
initiating the computed appraisal information to be transmitted from the server to an electronic display device.
